(19) United States
(12) Patent Application Publication
(10) Pub. No.: US 2020/0405564 A1
(43) Pub. Date: Dec. 31, 2020

(54) GAIT TRAINING SYSTEM

(71) Applicant: Valerie Gibson, Fairfax, VA (US)

(72) Inventor: Valerie Gibson, Fairfax, VA (US)

(21) Appl. No.: 16/915,249

(22) Filed: Jun. 29, 2020

Related U.S. Application Data
(60) Provisional application No. 62/868,177, filed on Jun. 28, 2019.

(51) Int. Cl. A61H 1/02; A61H 3/04; G06F 3/01

(52) U.S. Cl. CPC A61H 1/0262; A61H 3/04; A61H 2003/007; A61H 1/0266; G06F 3/011

(57) ABSTRACT

A gait training system for training rehabilitating legs includes a pair of gait-formulating assembly, a pair of pivotal shafts, a pair of foot plates, a controller and an input panel. The gait-formulating assembly includes a first actuator for sliding a first slider along a horizontal track, and a second actuator for sliding a second slider along a vertical track, in which the vertical track is disposed at the first slider. The pivotal shaft extending outward from the second slider is to pivotally connect the corresponding the foot plate. The controller is used for controlling actions of the first actuators and the second actuators to generate a desired trajectory. The input panel is used for inputting parameters and commands to determine the actions of the first actuators and the second actuators.

### CROSS REFERENCE TO RELATED APPLICATION

This application claims the benefits of U.S. provisional patent application No. 62/868,177, filed Jun. 28, 2019, the disclosures of which are incorporated by references herein in its entirety.

### TECHNICAL FIELD

The present disclosure relates in general to a physical therapy device, and more particularly to an active gait training system.

### BACKGROUND

Walking is one of the most common basic daily exercises. However, to people suffering from diseases or injuries including strokes, neurological injuries, and other conditions, this essential walking or even standing ability may be significantly reduced or completely lost. Nevertheless, many of these temporarily handicapped people can benefit from specific rehabilitation such as physical therapy to improve or regain their walking and standing ability.

In the art, various researches have been devoted to the re-establishment of patients' walking and standing ability. In particular, stand training with load is known to have varied positive therapeutic effects including improvements in circulatory, gastrointestinal and bowel controls, in respiratory functions, in bone mineral density, in motor functions, and in the range of motion for patients with neurological or other injuries. In a typical stand training, replicating motion of a specific gait cycle is usually introduced to increase corresponding muscle strengths.

In particular, in a popular therapy for re-establishing standing and walking ability, a robotic exoskeleton is utilized to repetitively impose estimates of normal gait cycles with an appropriate body-weight support. However, the robotic exoskeletons as well as current similar devices for serving the same purposes are usually exceedingly expensive, require highly trained operators, and are unable to be properly applied without qualified operator intervention.

On the other hand, conventional treadmills and driven footplates with body-weight supports may be less expensive, yet the associated capability in walking and standing training is strictly limited. In addition, while the body-weight support mechanism is capable of lifting patients into a standing position with a remarkable load reduction at the load at the patient's legs and feet, it does not provide assistance in leg ambulation.

Also, in the art of rehabilitation technology, Functional Electrical Stimulation (FES) is a well-known and well-regarded technique whereby electrical pulses are applied to weak or paralyzed muscles through electrodes temporarily adhered to patient's skin, so as to stimulate muscle contractions. Benefits of FES include improved physical integrity, increased muscle size and strength, reduced spasticity, and enhanced neurological performance FES can be applied to initiate muscle reactions for functional movements, including cycling and walking. Emerging research indicates that neural restoration is possible and significant literature exists to support the positive role of FES in improving the activity-dependent neural plasticity. Though many advantages from FES are obvious, yet existing leg and arm cycles are exceedingly costly and of limited functionality. FES has also been incorporated into other devices which replicate walking motion, but again, these devices are expensive and typically are only available at well-funded clinics.

The benefit of sensory feedback, visual or otherwise, is readily known, but traditional gait replication devices do not include any sensory feedback to patient for reinforcing the actions that the gait replication device is intended to produce. Sensory feedback ties in the user's other senses, and helps create a connection between the senses, which has been shown to assist in the development of the meaningful neurological connections within the body. Clinical trials have shown significant gait improvement in patients with Parkinson's disease utilizing a virtual reality apparatus.

### SUMMARY

Accordingly, an object of the present disclosure is to provide a gait training system integrated with low-cost structures and simplified mechanisms for assisting foot gaits, such that an affordable system with FES units can be provided to patients with spinal cord or other injuries.

In one aspect of the instant invention, a gait training system includes a main frame, a pair of gait-formulating assembly, a pair of pivotal shafts, a pair of foot plates, a controller and an input panel.

The pair of gait-formulating assembly is disposed at the main frame by standing roughly in parallel to form there inside a Training Space, hereby referred to as TS. Each of the pair of the gait-formulating assembly includes a module body, a first track, a first slider, a first actuator, a second track, a second slider and a second actuator. The module body is disposed on the main frame. The first track is disposed horizontally at the module body. The first slider is used for sliding along the first track. The first actuator, disposed at the module body, is used for moving the first slider along the first track. The second track, disposed at the first slider, is extended linearly downward from the first slider. The second slider, used for sliding along the second track, has a through hole perpendicular to the second track. The second actuator is disposed at the first slider to move the second slider linearly and up and down with respect to the first slider.

Each of the pair of pivotal shafts has two opposite ends, one end of the two opposite ends being installed to the corresponding through hole of the respective second slider while another end thereof extends into the TS perpendicularly with respect to the second slider.

Each of the pair of foot plates is pivotally connected with the other end of the pivotal shaft in the TS.

The location of the pivotal connection to the foot plate is adjustable fore or aft.

The controller, is electrically coupled with the first actuator and the second actuator for controlling actions of the first actuator and the second actuator.

The input panel, is electrically coupled with the controller for inputting parameters and commands to fulfill the actions of the first actuator and the second actuator.

In one embodiment of this disclosure, each of the first actuator and the second actuator is a stepper motor.

In one embodiment of the instant invention, the end of the pivotal shaft is fixedly or pivotally connected with the corresponding second slider, while another end is connected to the corresponding foot plate.

In one embodiment of the instant invention, the location of the connection of the pivotal point where connected to the foot plate, is adjustable vertically and horizontally, relative to the foot plate.

In one embodiment of the instant invention, each of the pair of foot plates is furnished with a foot-fixing member that secures a foot to the foot plate.

In one embodiment of the instant invention, the foot-fixing member is a Velcro strap in a loop-and-hoop configuration.

In one embodiment of the instant invention, the parameters and the commands to be inputted through the input panel include variables standing for stride lengths, step heights, step speeds, horizontal offsets, vertical offsets, gait profiles, phases, and independent adjustability of the aforementioned variables.

In one embodiment of the instant invention, the vertical offset can be adjusted such that the foot plates make contact with the floor, enabling the motion of the gait training assembly to propel the system.

In one embodiment of the instant invention, the input panel is an interface whereby an operator can input parameters to the Arduino microcontroller.

In one embodiment of the instant invention, the gait training system further includes a body-weight supporter installed to the main frame for bearing a percentage of body weight of a user.

In one embodiment of the instant invention, the body-weight support is adjustable in position with respect to the main frame, which will allow the main frame to support a percentage of a user's body weight, while allowing limited vertical motions.

In one embodiment of the instant invention, the gait training system further includes a plurality of functional electrical simulation (FES) units electrically coupled with the controller for applying sequenced functional electrical pulses to the muscles of a user.

In one embodiment of the instant invention, the gait training system includes haptic feedback to the patient in the form of vibrating knee pads, which can be synced to the gait.

In one embodiment of the instant invention, the gait training system includes a virtual reality setup, which is in the form of an immersive virtual reality headset, accompanied by audio input to match the visual stimulus.

In one embodiment of the instant invention, the gait training system includes a virtual reality setup, which is in the form of a visual panel, placed in front of the patient, which includes “picture in picture” views of the patient's feet along with some walking scenario. This is also accompanied by audio input to match the visual stimulus.

In one embodiment of the instant invention, the gait training system includes a system by which the patient is presented with visual stimulus of their own feet as if they were in a third person perspective. In one embodiment of the instant invention, the gait training system further includes a plurality of wheels mounted under the main frame for an operator to displace the gait training system.

In another aspect of this disclosure, a gait training system includes a main frame, a pair of gait-formulating assembly, a pair of pivotal shafts, a pair of foot plates, a controller and an input panel. The pair of gait-formulating assembly are disposed at the main frame by standing vertically in parallel and in a back-to-back manner to each other by a predetermined gap. Each of the pair of the gait-formulating assembly includes a module body, a first track, a first slider, a first actuator, a second track, a second slider and a second actuator. Namely, in this embodiment, the training space TS is therefore bisected into a left training space and right training space. The module body is disposed on the main frame. The first track is disposed horizontally at the module body. The first slider is used for sliding along the first track. The first actuator, disposed at the module body, is used for moving the first slider along the first track. The second track, disposed vertically at the first slider, is extended linearly downward from the first slider. The second slider, used for sliding along the second track, has a through hole perpendicular to the second track. The second actuator is disposed at the first slider to move the second slider linearly and vertically up and down with respect to the first slider. Each of the pair of pivotal shafts has two opposite ends, one end of the two opposite ends being installed to the corresponding through hole of the respective second slider while another end thereof extends perpendicularly and outward with respect to the second slider. Each of the pair of foot plates is pivotally connected with the other end of the pivotal shaft external to the pair of gait-formulating assembly. The controller, disposed at the main frame, is electrically coupled with the first actuators and the second actuators for controlling actions of the first actuators and the second actuators. The input panel, disposed at the main frame, is electrically coupled with the controller for inputting parameters and commands to fulfill the actions of the first actuators and the second actuators.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic front view of a first embodiment of the gait training system in accordance with this disclosure;

FIG. 2 is a schematic top view of FIG. 1;

FIG. 3 shows schematically a feasible region of the gait-formulating module of FIG. 1;

FIG. 4 is a schematic front view of a second embodiment of the gait training system in accordance with this disclosure;

FIG. 5 is a schematic top view of FIG. 4;

FIG. 6 is a schematic front view of the foot plates in accordance with this disclosure;

FIG. 7 is a schematic side view of FIG. 6;

FIG. 8 is a schematic perspective view of FIG. 6;

FIG. 9 is a flow chart showcasing the signals sent to each component throughout the system.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

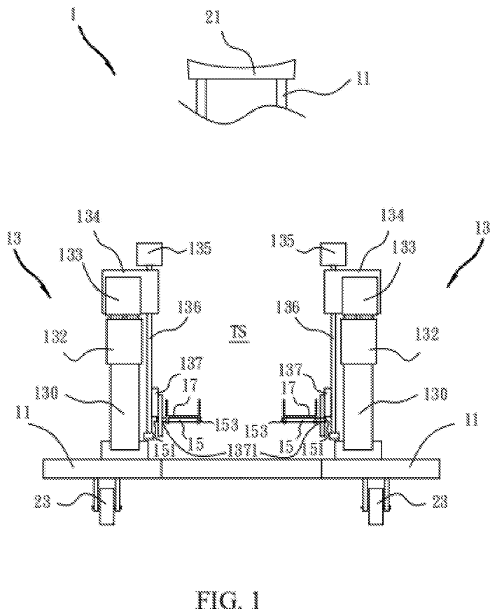

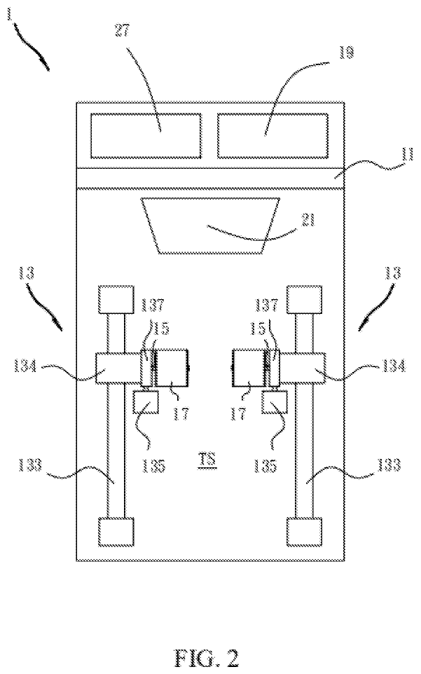

Referring to FIG. 1 and FIG. 2, a first embodiment of the gait training system in accordance with this disclosure is shown schematically in a front view and a top view, respectively.

As shown, in this embodiment, the gait training system 1 includes a main frame 11, a pair of gait-formulating assembly 13, a pair of pivotal shafts 15, a pair of foot plates 17, a controller 19 and an input panel (not shown in the figure).

The main frame 11 defines a base structure for mounting the rest of the aforesaid members and other accessory components for establishing this gait training system 1. In the figures, in order not to obscure other important members of this embodiment, part of the main frame 11 have been omitted. However, to those skilled in the art, it shall be understood that the main frame 11 of this disclosure can be made up by frames (like this embodiment), blocks, or other materials.

The pair of gait-formulating assembly 13 is disposed at the main frame 11 by standing in parallel to form there inside a training space TS. Each of the gait-formulating assembly 13 includes a module body 130, a first actuator 132, a first track 133, a first slider 134, a second actuator 135, a second track 136 and a second slider 137. The module body 130 is disposed on the main frame 11. The first actuator 132 disposed at the module body 130 is to move linearly the first slider 134 back and forth along the first track 133 extending linearly in a horizontal direction. The second actuator 135 disposed at the first slider 134 is to move linearly the second slider 137 back and forth along the second track 136 extending linearly and downward in a vertical direction from the first slider 134. In this embodiment, the first track 133 is perpendicular to the second track 136, and the whole set of the second actuator 135, the second track 136 and the second slider 137 is moved with the first slider 134.

The two gait-formulating assembly 13 are mounted upright roughly in parallel and symmetrically to each other, by having the individual sets of the second actuator 135, the second track 136 and the second slider 137 to face each other; i.e., by locating to a side of the gait-formulating module 13 facing the training space TS. A lower end of the second slider 137 is furnished with a through the hole 1371 extending perpendicular to a plane spanned by the first track 133 and the second track 136. In this embodiment, each of the first actuators 132 and the second actuators 136 can be a stepper motor, a servo motor, or other motor.

Each of the pivotal shafts 15 has two opposite ends, one end 151 of the two opposite ends being installed to the corresponding through the hole 1371 of the respective second slider 17 while another end 153 thereof extends into the training space TS by being perpendicular to the respective second slider 137. In this embodiment, the end 151 of the pivotal shaft 15 can be fixedly or pivotally connected with the corresponding through hole 1371 of the respective second slider 137, while, anyhow, the another end 153 thereof is pivotally connected with the corresponding foot plate 17.

Each of the foot plates 17, pivotally connected with the other end 153 of the pivotal shaft 15 in the training space TS, is used for landing a foot of a user. In considering that the user may be a patient suffering from foot drop or other motion problems, certain foot-fixing members shall be used for fixing the foot on the corresponding pedal shaft 17, such that no separation between the foot plate 17 and user's foot can exist during a training following the selected or defined trajectory. Preferably, the foot-fixing member is a Velcro strap in a loop-and-hoop configuration.

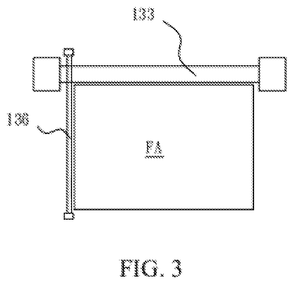

The controller 19, disposed at the main frame 11, is electrically coupled with the pair of the gait-formulating assembly 13 for controlling actions of the first actuators 132 and the second actuators 136 so as to determine positions of the pivot shafts 15. Referring to FIG. 3, all positions that the end 151 of the corresponding pivotal shaft 15 can reach are to occupy a vertical area defined as a feasible region FA.

The input panel (not shown in the figures), disposed at the main frame 11, is electrically coupled with the controller 19 for inputting parameters and commands to fulfill the actions of the first actuators 132 and the second actuators 136. In this embodiment, the input panel can be used to select a predetermined trajectory pattern or to define a customized trajectory pattern for the controller 19 to control the ends 151 of the pivotal shafts 15 to follow. Through this trajectory arrangement, the muscles of a patient legs with feet fixed to the corresponding foot plates 17 can be purposely and reciprocally trained by the actions of the first actuators 132 and the second actuators 136 controlled by the controller 19. Preferably, the two gait-formulating assembly 13 are controlled to follow the selected or defined trajectory by a predetermined phase lag.

In this embodiment, in order to determine a predetermined trajectory pattern or to define a specific trajectory pattern for the corresponding pivotal shaft 15 to follow, related parameters and commands including variables such as stride lengths, step heights, step speeds, horizontal offsets, vertical offsets, gait profiles, phases, and independent adjustability of the aforementioned variables can be inputted through the input panel via appropriate means such as key-in or button selections by the input panel. In one embodiment of this disclosure, the input panel can be a panel of an Arduino microcontroller.

As shown in FIG. 1 and FIG. 2, the gait training system 1 can further include a body-weight supporter 21 installed to the main frame 11 for bearing a body weight of a user. The body-weight supporter 21 is positioned at a place for the user can extend his/her legs into the training space TS, and to have his/her feet to be fixed with the corresponding foot plates 17 of the respective gait-formulating assembly 13. In addition, with an opposite side of the training space TS with respect to the side having the body-weight supporter 21 to be open, a user on a wheelchair can experience the training of the gait training system 1 by directly pushing the wheelchair to approach the training space TS from the open side thereof.

In this disclosure, the gait training system 1 can further include a plurality of functional electrical simulation (FES) units electrically coupled with the controller 19 for performing functional electrical pulses to muscles of a user. The art of FES is already familiar to the persons skilled in the related fields, and thus details thereabout would be omitted herein.

As shown in FIG. 1, the gait training system 1 can further include a plurality of wheels 23 mounted under the main frame 11 for displacing the gait training system, for adjusting the system 1 to align the training space TS to a wheelchair, or to allow the system 1 to displace itself under the power of the gait formulating assembly 13.

In addition, according to this disclosure, the gait training system 1 can be energized by a municipal electricity source (not shown in the figures) or a battery set 27.

Also, in the figures, since applications of electric wiring, transmission linkages, and some mechanical components such as clips, washers, bearings, screws, bolts, bushes, mounting jigs and linings are well known in the art, thus symbols and descriptions thereto are omitted herein, and also through the following drawings. To the skill in the art, such omitting shall not cause any ambiguity to the embodiments of this disclosure.

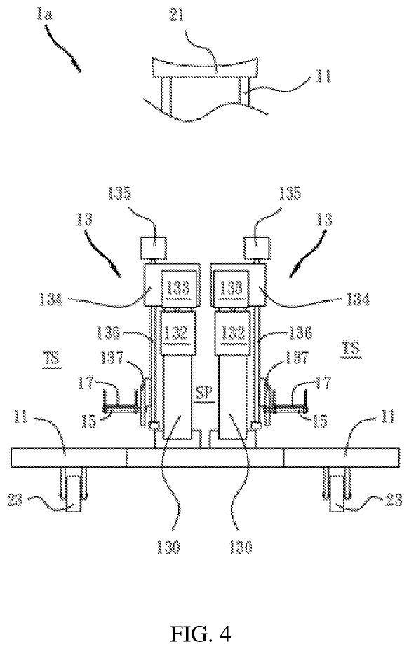

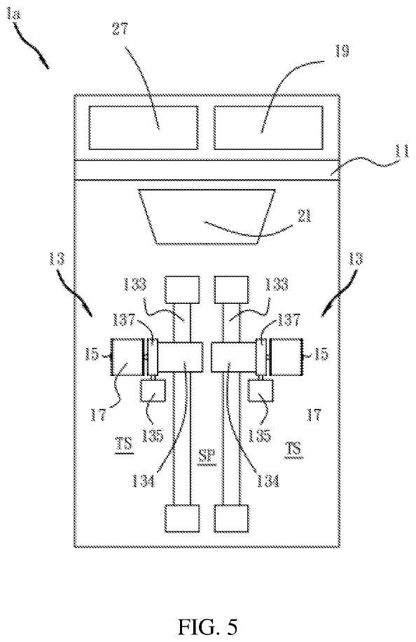

Referring now to FIG. 4 and FIG. 5, a second embodiment of the gait training system in accordance with this disclosure is shown schematically in a front view and a top view, respectively.

As shown, in this embodiment, the gait training system 1a includes a main frame 11, a pair of gait-formulating assembly 13, a pair of pivotal shafts 15, a pair of foot plates 17, a controller 19 and an input panel (not shown in the figure).

The main frame 11 defines a base structure for mounting the rest of the aforesaid members and other accessory components for establishing this gait training system 1. In the figures, in order not to obscure other important members of this embodiment, part of the main frame 11 have been omitted. However, to the skill in the art, it shall be understood that the main frame 11 of this disclosure can be made up by frames (like this embodiment), blocks, or other relevant materials.

The pair of gait-formulating assembly 13 are disposed at the main frame 11 by standing in parallel and in a back-to-back manner to form therebetween a gap SP, and the training space TS of this embodiment is divided into two external to the both sides of the two gait-formulating assembly 13. Namely, in this embodiment, the training space TS is therefore bisected into a left training space and right training space. Each of the gait-formulating assembly 13 includes a module body 130, a first actuator 132, a first track 133, a first slider 134, a second actuator 135, a second track 136 and a second slider 137. The first actuator 132 disposed at the module body 130 is to move linearly the first slider 134 back and forth along the first track 133 extending linearly in a horizontal direction. The second actuator 135 disposed at the first slider 134 is to move linearly the second slider 137 back and forth along the second track 136 extending linearly and downward in a vertical direction from the first slider 134. Namely, in this embodiment, the first track 133 is perpendicular to the second track 136, and the whole set of the second actuator 135, the second track 136 and the second slider 137 is moved with the first slider 134.

The two gait-formulating assembly 13 are mounted upright in parallel and in a back-to-back manner close to each other, by having the individual sets of the second actuator 135, the second track 136 and the second slider 137 to face outward; i.e., by having the two gait-formulating assembly 13 to separate the training space TS. A lower end of the second slider 137 is furnished with a through hole 1371 extending perpendicular to a plane spanned by the first track 133 and the second track 136. In this embodiment, each of the first actuators 132 and the second actuators 136 can be a stepper motor, a servo motor, or a similar motor.

Each of the pivotal shafts 15 has two opposite ends, one end 151 of the two opposite ends being installed to the corresponding through hole 1371 of the respective second slider 137 while another end 153 thereof extends into the corresponding training space TS by being perpendicular to the respective second slider 137. In this embodiment, the end 151 of the pivotal shaft 15 can be fixedly or pivotally connected with the corresponding through hole 1371 of the respective second slider 137, while, anyhow, the another end 153 thereof is pivotally connected with the corresponding foot plate 17.

Each of the foot plates 17, pivotally connected with the other end 153 of the pivotal shaft 15 in the respective training space TS, is used for landing a foot of a user. In considering that the user may be a patient suffering from foot drop or other motion problems, certain foot-fixing members shall be used for fixing the foot on the corresponding pedal shaft 17, such that no separation between the foot plate 17 and user's foot can exist during a training following the selected or defined trajectory.

The controller 19, disposed at the main frame 11, is electrically coupled with the pair of the gait-formulating assembly 13 for controlling actions of the first actuators 132 and the second actuators 136 so as to determine positions of the pivot shafts 15.

The input panel (not shown in the figures), disposed at the main frame 11, is electrically coupled with the controller 19 for inputting parameters and commands to fulfill the actions of the first actuators 132 and the second actuators 136. In this embodiment, the input panel can be used to select a predetermined trajectory pattern or to define a customized trajectory pattern for the controller 19 to control the ends 151 of the pivotal shafts 15 to follow. Through this trajectory arrangement, the muscles of a patient legs with feet fixed to the corresponding foot plates 17 can be purposely and reciprocally trained by the actions of the first actuators 132 and the second actuators 136 controlled by the controller 19. Preferably, the two gait-formulating assembly 13 are controlled to follow the selected or defined trajectory by a predetermined phase lag. More preferably, the predetermined phase lag is 180°.

In this embodiment, in order to determine a predetermined trajectory pattern or to define a specific trajectory pattern for the corresponding pivotal shaft 15 to follow, related parameters and commands including variables such as stride lengths, step heights, and step speeds can be inputted through the input panel via appropriate means such as key-in, button selections or nodal turning provided by the input panel. In one embodiment of this disclosure, the input panel can be a panel of an Arduino microcontroller.

As shown, the gait training system 1a can further include a body-weight supporter 21 installed to the main frame 11 for bearing a body weight of a user. The body-weight supporter 21 is positioned at a place for the user can extend and separate his/her two legs into the corresponding training spaces TS across the pair of the gait-formulating assembly 13, and to have his/her feet to be fixed with the corresponding foot plates 17 of the respective gait-formulating assembly 13. In addition, a user on a wheelchair can experience the training of the gait training system 1a by directly pushing the wheelchair, from a side opposite to the body-weight supporter 21 to have the pair of the gait-formulating assembly 13 to be positioned between the two legs of the user on the wheelchair, so that each leg of the user can be trained by the corresponding gait-formulating module 13 in the respective training space TS.

In this disclosure, the gait training system 1a can further include a plurality of functional electrical simulation (FES) units electrically coupled with the controller 19 for performing functional electrical pulses to muscles of the user, and a plurality of wheels 23 mounted under the main frame 11 for displacing the gait training system 1a or adjusting the positions of the two gait-formulating assembly 13 between user's legs.

In addition, according to this disclosure, the gait training system 1a can be energized by an external electricity source (not shown in the figures) or a battery set 27.

As described above, the gait training system provided by this disclosure introduces simplified mechanisms to perform trajectory-following motions for rehabilitating legs such that gait training can be provided in an affordable, easy and safely operable way.

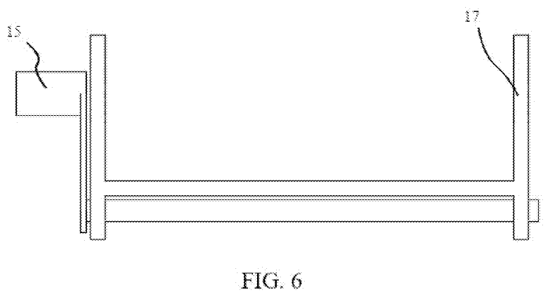

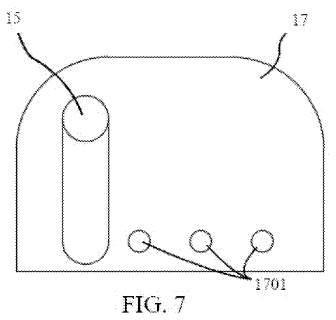

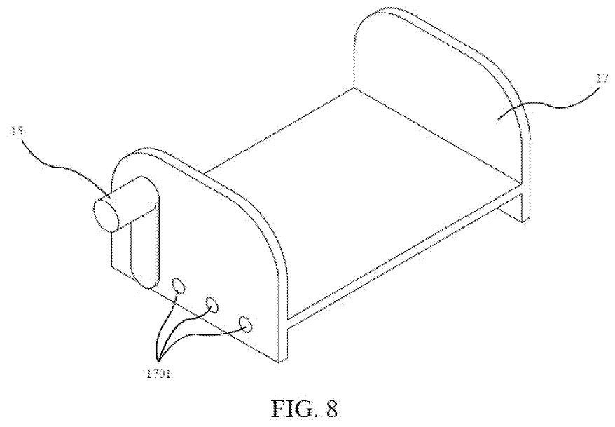

Referring now to FIG. 6, FIG. 7, and FIG. 8, a detailed view of the foot plates in accordance with this disclosure is shown schematically in a front view, top view, and perspective view, respectively.

In this embodiment, the foot plate assembly is made up of a pivotal shaft 15 and a foot plate 17, with through-holes 1701.

As shown, pivotal shaft 15 can be removed and slotted into the through holes 1701 in foot plate 17 in order to move the pivot point fore or aft.

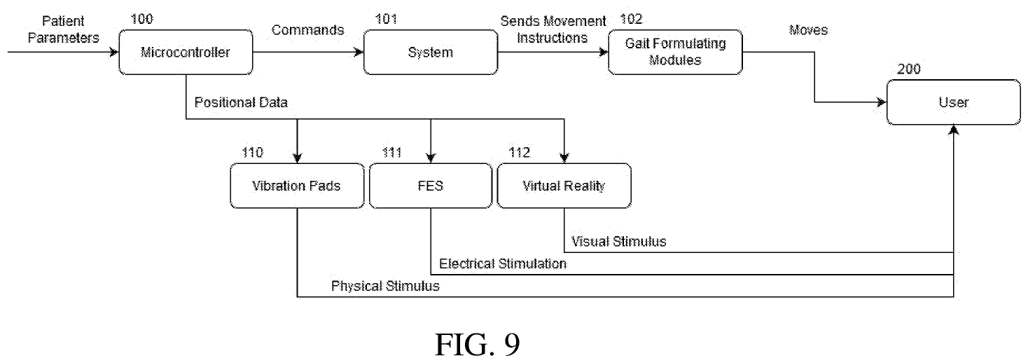

Referring now to FIG. 9, a flowchart showcasing the types of sensory feedback/stimulations to the user that the system provides.

As shown, microcontroller 100 accepts patient parameters, and sends commands to system 101 and positional data to vibration pads 110, FES 111, and virtual reality 112. System 101 sends movement instructions based on the patient parameters received from microcontroller 100 to gait formulating assembly 102. Gait formulating assembly 102 then move the user 200. Vibration pads 110, FES 111, and virtual reality 112 all send their stimuli to the user 200 as corresponding sensory feedback.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A gait training system, comprising:
a main frame;
a pair of gait-formulating assembly, disposed at the main frame by separately standing to form thereinside a training space, each of the pair of the gait-formulating assembly including:
a module body, disposed on the main frame;
a first track, disposed at the module body;
a first slider, used for sliding along the first track;
a first actuator, disposed at the module body for moving the first slider along the first track;
a second track, disposed at the first slider, extending downward linearly from the first slider;
a second slider, used for sliding along the second track, having a through hole perpendicular to the second track;
a second actuator, disposed at the first slider to move the second slider up and down with respect to the first slider;
a pair of pivotal shafts, each of the pair of pivotal shafts having two opposite ends, one end of the two opposite ends being installed to the corresponding through hole of the respective second slider while another end thereof extends into the training space perpendicularly with respect to the second slider;
a pair of foot plates, each of the pair of foot plates being pivotally connected with the another end of the pivotal shaft in the training space;
a foot fixing-member, securing a user's foot to the corresponding foot plate;
a controller electrically coupled with the first actuators and the second actuators, used for controlling actions of the first actuators and the second actuators; and
an input panel electrically coupled with the controller, used for inputting parameters and commands to fulfill the actions of the first actuator and the second actuator.

2. The gait training system of claim 1, wherein each of the first actuator and the second actuator is a stepper motor.

3. The gait training system of claim 1, wherein each of the first actuator and the second actuator is a servo motor.

4. The gait training system of claim 1, wherein the end of the pivotal shaft is fixedly connected with the corresponding second actuator.

5. The gait training system of claim 1, wherein the end of the pivotal shaft is pivotally connected with the corresponding second actuator.

6. The gait training system of claim 1, the connection point where the pivotal connector is pivotally connected to the foot plate is adjustable horizontally, vertically, fore, and aft.

7. The gait training system of claim 1, wherein the foot-fixing member is a Velcro strap in a loop-and-hoop configuration.

8. The gait training system of claim 1, wherein the parameters and the commands include variables standing for stride lengths, step heights, step speeds, horizontal offsets, vertical offsets, gait profiles, phases, and independent adjustability of the aforementioned variables.

9. The gait training system of claim 1, further including a body-weight supporter installed to the main frame for bearing a body weight of a user.

10. The gait training system of claim 1, further including a body-weight supporter installed to the main frame for partially bearing the body weight of a user.

11. The gait training system of claim 1, further including a plurality of functional electrical simulation (FES) units electrically coupled with the controller for performing functional electrical pulses to muscles of a user.

12. The gait training system of claim 1, further including a virtual reality system electrically coupled with the controller for providing the user a more holistic walking simulation.

13. The gait training system of claim 1, further including a plurality of sensory feedback, visual, haptic, or otherwise.

14. The gait training system of claim 1, further including a plurality of wheels mounted under the main frame for displacing the gait training system.

15. A gait training system, comprising:
a main frame;
a pair of gait-formulating assembly, disposed at the main frame by separately standing in a back-to-back manner to each other, each of the pair of the gait-formulating assembly including:
a module body, disposed on the main frame;
a first track, disposed at the module body;
a first slider, used for sliding along the first track;
a first actuator, disposed at the module body for moving the first slider along the first track;
a second track, disposed at the first slider, extending linearly downward from the first slider;
a second slider, used for sliding along the second track, having a through hole perpendicular to the second track;
a second actuator, disposed at the first slider to move the second slider up and down with respect to the first slider;
a pair of pivotal shafts, each of the pair of pivotal shafts having two opposite ends, one end of the two opposite ends being installed to the corresponding through hole of the respective second slider while another end thereof extends perpendicularly with respect to the second slider;
a pair of foot plates, each of the pair of foot plates being pivotally connected with the another end of the pivotal shaft external to the pair of gait-formulating assembly;
a controller, disposed at the main frame, electrically coupled with the first actuator and the second actuator, used for controlling actions of the first actuator and the second actuator; and
an input panel, disposed at the main frame, electrically coupled with the controller, used for inputting parameters and commands to fulfill the actions of the first actuator and the second actuator.

16. The gait training system of claim 15, wherein each of the first actuator and the second actuator is a stepper motor.

17. The gait training system of claim 15, wherein the end of the pivotal shaft is fixedly connected with the corresponding second actuator.

18. The gait training system of claim 15, wherein the end of the pivotal shaft is pivotally connected with the corresponding second actuator.

19. The gait training system of claim 15, wherein the foot-fixing member is a Velcro strap in a loop-and-hoop configuration.

20. The gait training system of claim 15, wherein the parameters and the commands include variables standing for stride lengths, step heights, and step speeds, horizontal offsets, vertical offsets, gait profiles, phases, and independent adjustability of the aforementioned variables.

21. The gait training system of claim 15, wherein the input panel is a panel of an Arduino simulator.

22. The gait training system of claim 15, further including a body-weight supporter installed to the main frame for bearing a body weight of a user.

23. The gait training system of claim 15, further including a plurality of functional electrical simulation (FES) units electrically coupled with the controller for performing functional electrical pulses to muscles of a user.

24. The gait training system of claim 12, further including a plurality of wheels mounted under the main frame for displacing the gait training system.

25. The gait training system of claim 1, further including a plurality of sensory feedback, visual, haptic or otherwise.

26. The gait training system of claim 1, further including virtual reality for more holistically simulating walking in a real environment.
